(19) United States
(12) Patent Application Publication
(10) Pub. No.: US 2010/0186545 A1
(43) Pub. Date: Jul. 29, 2010

(54) HANDLEBAR AUXILIARY ADJUSTABLE HAND GRIP EXTENSION

(76) Inventor: William Ray, Greene, NY (US)

Correspondence Address: DONALD W. MEEKER, 924 EAST OCEAN FRONT, # E, NEWPORT BEACH, CA, 92661, US

(21) Appl. No.: 12/362,319

(22) Filed: Jan. 29, 2009

(51) Int. Cl. B62K 21/16

(52) U.S. Cl. 74/551.8

(57) ABSTRACT

A hand grip T-bar fits pivotally in a quick release lock attached to a handlebar support. The hand grip T-bar is locked forward of the handlebar for normal use of the handlebar by a rider. The hand grip T-bar is pivoted above the handlebar toward the rider in a desired position for the rider to grip the hand grip T-bar to operate the vehicle with the rider seated in an upright position to relieve back strain.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to cycle handlebar grips and in particular to an auxiliary hand grip T-bar with a pair of end hand grips which has a base permanently attached to a handle bar support with a horizontal pivot arm within a quick-release lever sleeve so that the auxiliary hand grip T-bar may be locked in a down forward position in front of the regular handle bar for use of the regular handle bar, and tilted up and back so that the rider grips the auxiliary hand grip T-bar while riding in an upright sitting position on the cycle seat.

2. Description of Related Art Including Information Disclosed Under 37 CFR 1.97 and 1.98

In riding a bicycle, the normal crouched down position for least wind resistance in racing or riding for speed becomes very uncomfortable and creates a lower back strain if maintained for long periods of time. The hand grip position on many bicycles, especially racing bicycles, is positioned very low to enable the streamlined crouched position of the rider.

The prior art does not adequately address the problem of back strain and fatigue for bicycle riders over long distances.

U.S. Patent Application #20080202281, published Feb. 28, 2008 by Bruyere, claims a handlebar extension (1) mountable on a bicycle (2), such as a touring bicycle or a mountain bike, comprising an original handlebar (3) fastened to a handlebar stem (3A), characterised in that said handlebar extension (1) comprises means (12A, 12B, 13, 14) for attaching pivotally said handlebar extension (1) to the original handlebar (3), so that said handlebar extension (1) is free to rotate about the axis of the original handlebar (3) during riding, providing to the user a number of equilibrium riding positions.

U.S. Pat. No. 5,570,614, issued Nov. 5, 1996 to Nastrucci, is for an adjustable bicycle handlebar mounting assembly comprising a stem including a portion for mounting to the stem tube of a bicycle and two parallel jaws for receiving tubular elements. The jaws are adjustable to enable the tubular elements to selectively positioned in the length direction of the bicycle. A handlebar mounting element for use with the stem comprises two parallel bores which are mountable to the tubular elements, and a jaw orthogonal to the two parallel bores for housing a handlebar. The handlebar is adjustable in the width direction of the bicycle. A clamping element comprises seats for housing two half-handlebars, and a fastening element. The clamping element enables the half-handlebar position to be adjusted relative to the stem, while maintaining the half-handlebars fixed with respect to each other.

U.S. Pat. No. 6,662,680, issued Dec. 16, 2003 to Rocket, puts forth a system that adds a secondary handlebar to a bicycle that already is fitted with a primary set of handlebars. The system includes a secondary handlebar. The secondary handlebar is supported by a neck element. The neck element is attached to the steering post of the bicycle using a clamping assembly. The clamping assembly can engage the neck element at a variety of different points. Consequently, the height at which the neck element supports the secondary handlebar over the steering post can be selectively adjusted. Furthermore, at least one pivot adjustment is disposed between the steering post and the secondary handlebar. The pivot adjustment enables the secondary handlebar to be selectively adjusted along an arcuate path. As a result, the secondary handlebar can be adjusted both height and position in order to match the ergonomic needs of a particular rider.

U.S. Pat. No. 5,145,210, issued Sep. 8, 1992 to Lennon, is for handlebars for a bicycle including a central crosspiece connectable to a bicycle steering post and sidewardly extending portions which may include a pair of pads for supporting a rider's forearms. A generally vertical handgrip portion is located by an intermediate section to a forward central region to permit the rider's hands to overlap each other while grasping the vertical handgrip portion and define a rider position in which the rider's elbows are located near the central rear portion and the rider's arms extend forwardly when the rider's hands are grasping the vertical handgrip portion. In certain embodiments, the vertical handgrip may be T shaped with additional horizontal sections. In other embodiments, an adapter allows the generally vertical handgrip and intermediate section to be clamped to an original bicycle handlebar.

U.S. Pat. No. 5,429,013, issued Jul. 4, 1995 to Taylor et al, concerns climbing handles for road bicycles that mount on each side of the stem. The handles are to be set forward and above, in a parallel relationship to the standard handlebars. The climbing handles must be permanently and securely welded to clips that attach securely to the handlebars of a road bicycle. The top clips have a platform for the purpose of locating the climbing handles in the proper relationship to the standard handlebars. Bottom clips which correspond to the top clips are used to attach the climbing handles to standard bicycle handlebars.

U.S. Pat. No. 567,663, issued Sep. 15, 1896 to Snyder, illustrates auxiliary handlebars attached to existing handlebars to allow adjustment for a rider to sit bent over or straight up.

U.S. Pat. No. D289,630, issued May 5, 1987 to Owens, provides an ornamental design for an auxiliary bicycle handlebar attachment.

U.S. Pat. No. 599,564, issued Feb. 22, 1898 to Kintner, shows auxiliary bicycle handle grips attached to the handlebar.

U.S. Pat. No. 5,319,995, issued Jun. 14, 1994 to Huang, provides a handle assembly mounted detachably on one end of a bicycle handlebar and includes a resilient sleeve member that is sleeved on the bicycle handlebar, an integrally formed handle unit that is made of a composite plastic material, and a bolt unit. The integrally formed handle unit has a clamping portion and a handle portion that extends upwardly from the clamping portion. The handle portion has a generally vertical section that extends from the clamping portion, and a generally horizontal section that extends from a distal end of the vertical section. The vertical section of the handle portion is formed with at least one longitudinally extending reinforcing strip that is connected to the clamping portion. The clamping portion has a generally C-shaped section that confines a through-hole and that is sleeved on the first resilient sleeve member. The clamping portion further has two spaced-apart locking plates which extend from the generally C-shaped section and which cooperatively define a gap therebetween. The gap is communicated with the through-hole of the C-shaped section. The bolt unit fastens together the two locking plates so that the C-shaped section is in tight contact with the resilient sleeve member in order to prevent rotation and longitudinal movement of the clamping portion relative to the bicycle handlebar.

U.S. Pat. No. 5,033,325, issued Jul. 23, 1991 to Giard, describes a linkage for attaching an auxiliary handlebar having tubular ends to a bicycle handlebar having tubular ends includes a first member adapted to be axially secured and rotationally movable within each tubular end of the auxiliary handlebar and an adjustable linkage adapted to be variably positioned within each tubular end of the bicycle handlebar. Each adjustable linkage is pivotally attached to a first member in mounting the auxiliary handlebar to the bicycle handlebar.

U.S. Pat. No. 4,878,397, issued Nov. 7, 1989 to Lennon, shows novel handlebars for a bicycle including a crosspiece connected to a bicycle steering post with sideways portions extending therefrom. The handlebars of the invention have hand grip portions that are located relatively close together to encourage the rider to adopt a riding position in which the frontal area of the rider's silhouette is minimized, and in which the rider's elbows are located ahead of the rider's lungs. Turned handlebar portions extend from the sideways portions and extend generally forwardly and inwardly to define a pair of forward handle portions spaced apart a distance less than the width of the crosspiece. A front loop portion interconnects the forward handle portions so that all of the portions define a continuous loop forward of the steering post. A handlebar adapter is provided for a bicycle having an original handlebar. The adapter is a generally U-shaped extension loop that projects forwardly away from the rider and defines a pair of handgrip positions in which the rider's arms extend forwardly toward the handgrip portions and the rider's elbows are located near the original handlebar. An adapter is also provided for a bicycle with forwardly extending portions terminating in a pair of handgrips. The adapter includes structure to interconnect the pair of handgrips.

U.S. Pat. No. 7,213,485, issued May 8, 2007 to Huang, indicates a bicycle assistive handlebar structure installed at the anterior extent of a front fork stem, stem clamp mount that serves as a means of conjoinment. The stem clamp mount consists of a concave section and a threaded hole that provides for the fastening of bolts inserted via four through-holes. Furthermore, a vertical coupling passage is disposed through the installation crown, thereby providing for the horizontal arrangement of a handlebar in a connective mounting shank. The two sides of a transverse rod provides for the fitting into position of insertion sleeves, and an elongated hole provides for the stationary seating into the connective mounting shank elongated hole. Radial splines are respectively fabricated along the outer sides of the joint mount and the inner sides of an assistive handlebar. As such, the present invention provides the rider variable adjustment operation over upper and lower height, forward and backward distance, and rotative direction.

U.S. Pat. No. 5,154,095, issued Oct. 13, 1992 to Giard, discloses a bicycle handlebar construction provides a handlebar having first hand gripping portions and a forward extension having second hand gripping portions. There is a pair of arm rests mounted on the handlebars for support of a rider's arms when using the forward or second hand gripping portions. The arm rests are positioned a distance away from the first hand gripping portions to prevent interference therewith when the rider is using the first hand gripping portions.

What is needed is an adjustable auxiliary T-bar hand grip extension which pivots up above the regular handlebar and back toward the rider and locks, with a quick-release lock mechanism not requiring tools, with the cross bar and end handgrips elevated above the regular handlebar and back toward the rider to enable the rider to grip the auxiliary hand grip T-bar and straighten his or her back to sit up while riding to relieve back stress and/or pain, often experienced with the low handle bar.

### BRIEF SUMMARY OF THE INVENTION

An object of the present invention is to provide an adjustable auxiliary T-bar hand grip extension which pivots up above the regular handlebar and back toward the rider and locks, with a quick-release lock mechanism not requiring tools, with the cross bar and end handgrips elevated above the regular handlebar and back toward the rider to enable the rider to grip the auxiliary hand grip T-bar and to sit up while riding to straighten his or her back to relieve back stress and/or pain, often experienced with the low handle bar.

In brief, the pivotable T-bar grip of the present invention has a base welded onto the center support structure for the existing handlebars. A horizontal pivot bar with a quick release lever lock mechanism (not requiring tools) pivots around the base up to an elevated position locked in place by the quick release lever for use by a rider sitting in an upright position to relieve lower back stress. Upon release of the quick release lever the T-bar grip pivots forward and downward to be locked in place in front of the regular handle bar out of the way during normal operation of the bicycle combined with the (uneven) T-bar configuration which can be quickly released, repositioned, and locked in any position as desired.

The advantage of the present invention is that it has a quick-release lever, which allows the auxiliary grip T-bar to either adjust to the rider's riding preference or be pushed forward, completely out of the way to allow the rider to ride with the original handle bars.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a side elevational view of the adjustable auxiliary hand grip device of the present invention installed on a bicycle with the auxiliary hand grip pivoted back toward a rider for use by the rider in operating the bicycle while sitting upright on the bicycle seat;

FIG. 2 is a side elevational view of the adjustable auxiliary hand grip device of the present invention installed on a bicycle with the auxiliary hand grip pivoted forward in front of the regular handlebar to enable a rider to use the regular handlebar in a leaning forward position;

FIG. 3 is a perspective view of the adjustable auxiliary hand grip device of the present invention showing the auxiliary hand grip T-bar aligned for insertion into the quick-release lock;

FIG. 4 is a perspective view of the adjustable auxiliary hand grip device of the present invention showing the auxiliary hand grip T-bar inserted in the quick-release lock;

FIG. 5 is a side elevational view of the adjustable auxiliary hand grip device of the present invention installed on a handle bar support of a bicycle with the auxiliary hand grip pivoted forward in front of the regular handlebar to enable the rider to use the regular handlebar.

### DETAILED DESCRIPTION OF THE INVENTION

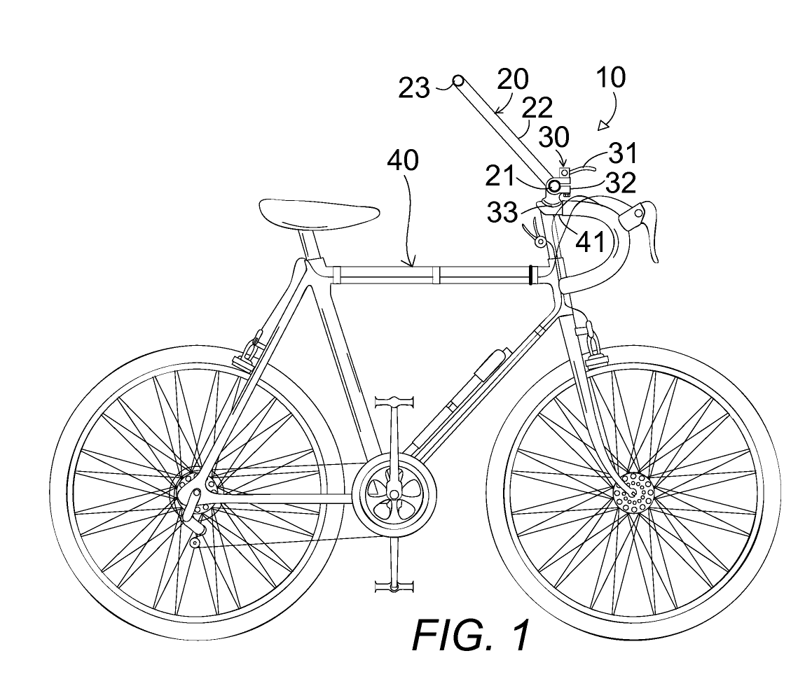

In FIGS. 1-5, an auxiliary adjustable hand grip device 10 for a vehicle, such as a bicycle 40, having a handlebar 43 secured by a handlebar support 41 is used alternately with the existing handlebar 43.

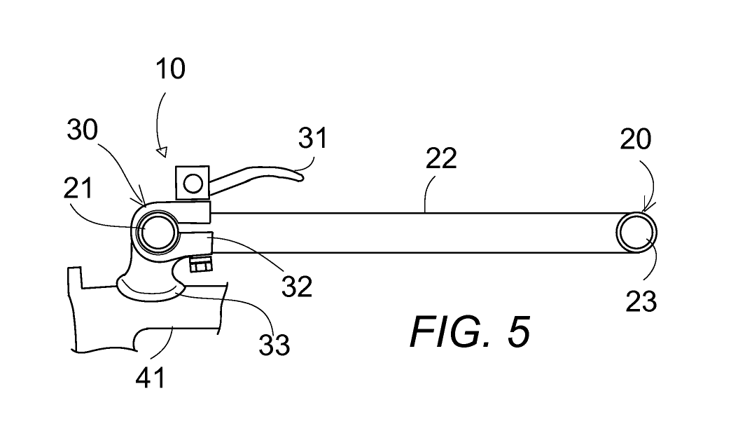

In FIG. 5, a base of a quick-release lock mechanism 30 is permanently attached, preferably by a welding connection 33, to a handle bar support 41 on a vehicle having a handlebar 43. The quick-release lock mechanism has a horizontal split sleeve 32 and a quick release lever arm 31 for alternately tightening the split sleeve 32 in a lock position and expanding the split sleeve 32 in a release position for pivoting the device.

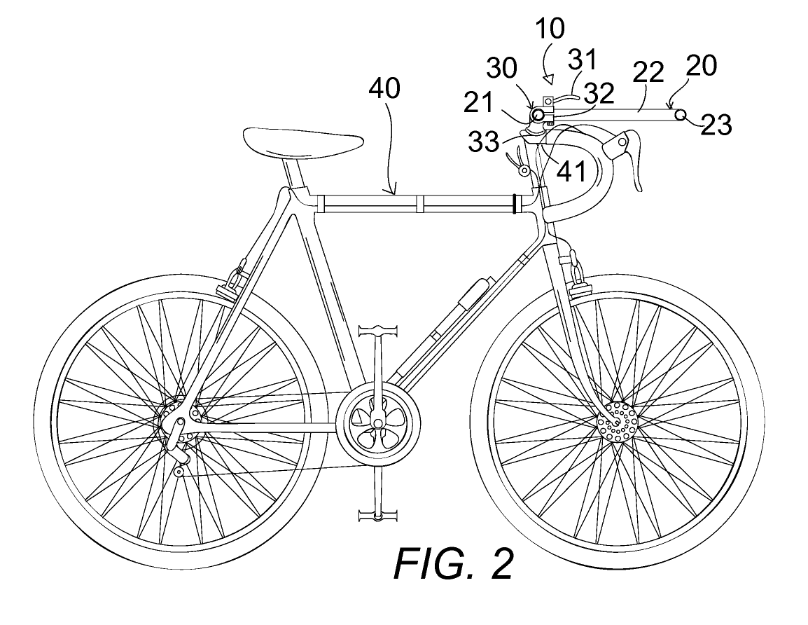

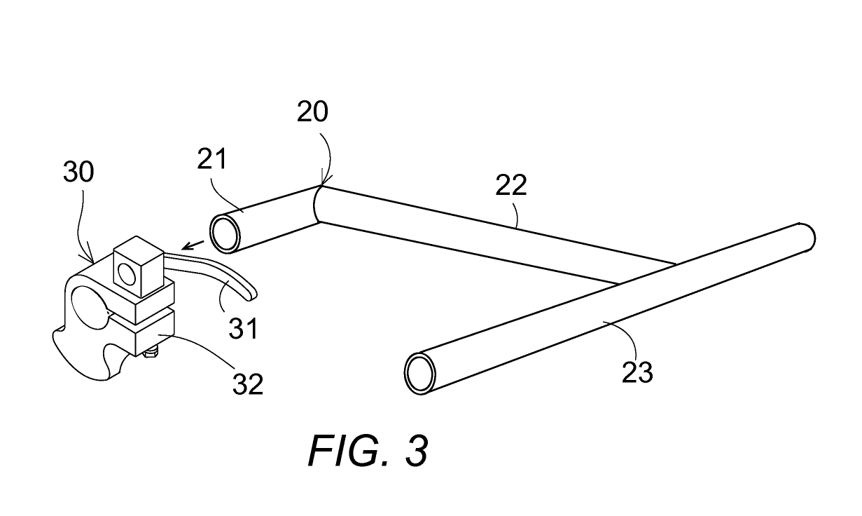

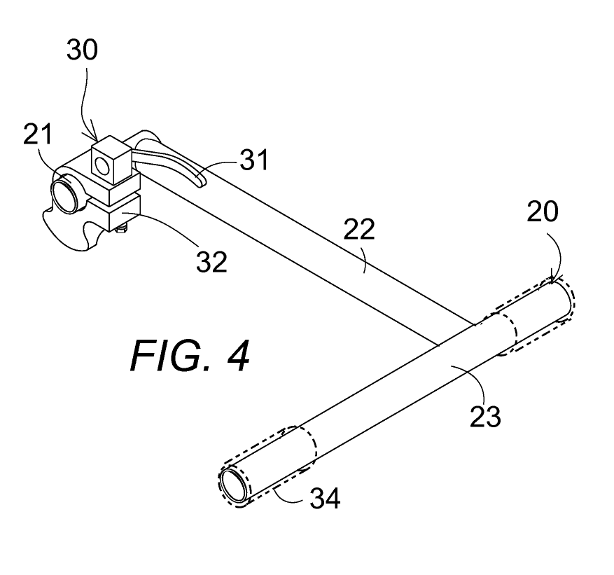

In FIGS. 3-5, an adjustable auxiliary hand grip T-bar 20 comprises a horizontal lock arm 21 fitting within the split sleeve 32 with a pivotable fit in the release position and a locked stationary fit in the lock position. An extension shaft 22 extends orthogonally from the lock arm 21. A horizontal hand grip cross arm 23 is secured orthogonally to an outer end of the extension shaft 22. When the adjustable auxiliary hand grip T-bar 20 is pivoted and locked in a position forward of the handlebar, as shown in FIGS. 2 and 5, normal use of the handlebar 43 is provided with the rider in a crouched forward position. When the adjustable auxiliary hand grip T-bar 20 is pivoted and locked in a position above and rearward of the handlebar enables, as shown in FIG. 1, a rider on a vehicle seat may grip the hand grip cross arm 23 for operation of the vehicle while the rider sits in an upright position on the seat to straighten the back of the rider to relieve back stress. The hand grip cross arm 23 may further comprise a hand grip surface 34, shown dashed in FIG. 4, at each end of the hand grip cross arm for gripping by a rider. The pivotable adjustable auxiliary hand grip T-bar 20 in the quick-release lock mechanism forms an auxiliary adjustable hand grip device for a vehicle having a handlebar which hand grip device may be quickly released, repositioned, and locked in any position as desired without the use of a tool.

In FIGS. 3 and 4, the adjustable auxiliary hand grip T-bar 20 is configured in an offset T-bar configuration having one end of the hand grip bar 23 extending longer than the other end from the extension shaft to compensate for an offset of the extension shaft from the center of the handlebar with the quick-lock 30 centrally positioned so that the hand grip bar ends are equidistant from the center of the handlebar for even positioning of the hands of the rider.

In use, the auxiliary hand grip T-bar 20 may be locked in a down forward position in front of the regular handle bar, as shown in FIGS. 2 and 5, for use of the regular handle bar 43 unobstructed by the adjustable auxiliary hand grip T-bar 20. The adjustable auxiliary hand grip T-bar 20 may be pivoted up and back toward the rider in any desired position, as shown in FIG. 1, to enable the rider to grip the auxiliary hand grip T-bar while riding in an upright sitting position on the cycle seat to relieve back stress and fatigue.

It is understood that the preceding description is given merely by way of illustration and not in limitation of the invention and that various modifications may be made thereto without departing from the spirit of the invention as claimed.

What is claimed is:

1. An adjustable auxiliary hand grip device for a vehicle having a handlebar used alternately with an existing handlebar, the device comprising:
a base permanently attached to a handle bar support on a vehicle having a handlebar, the base comprising a quick-release lock mechanism having a horizontal split sleeve and a lever arm for alternately tightening the split sleeve in a lock position and expanding the split sleeve in a release position;
an adjustable auxiliary hand grip T-bar comprising a horizontal lock arm fitting within the split sleeve with a pivotable fit in the release position and a locked stationary fit in the lock position, an extension shaft extending orthogonally from the lock arm, a horizontal hand grip cross arm secured orthogonally to an outer end of the extension shaft, so that the extension arm pivoted and locked in a position forward of the handlebar permits normal use of the handlebar with the rider in a crouched forward position and the extension arm pivoted and locked in a position above and rearward of the handlebar enables a rider on a vehicle seat to grip the hand grip cross arm for operation of the vehicle while the rider sits in an upright position on the seat to straighten the back of the rider to relieve back stress, thereby forming an auxiliary adjustable hand grip device for a vehicle having a handlebar which hand grip device may be quickly released, repositioned, and locked in any position as desired without the use of a tool.

2. The device of claim 1 wherein the base is attached to the handlebar support by a welded connection.

3. The device of claim 1 further comprising a hand grip surface at each end of the hand grip cross arm for gripping by a rider.

4. The device of claim 1 the extension shaft and the hand grip bar form an offset T-bar configuration having one end of the hand grip bar extending longer than the other end from the extension shaft to compensate for an offset of the extension shaft from the center of the handlebar with the quick-lock centrally positioned so that the hand grip bar ends are equidistant from the center of the handlebar for even positioning of the hands of the rider.
